(19) United States
(12) Patent Application Publication
(10) Pub. No.: US 2002/0106507 A1
(43) Pub. Date: Aug. 8, 2002

(54) Laminated book covers and attachment

(76) Inventor: John Boyd Weers, Renton, WA (US)

Correspondence Address: JOHN B. WEERS, 2019 NE 12TH ST, RENTON, WA, 98056, US

(21) Appl. No.: 09/776,621

(22) Filed: Feb. 5, 2001

(51) Int. Cl. B32B 7/12

(52) U.S. Cl. 428/354; 428/343; 428/99

(57) ABSTRACT

Use of plastic laminate on both sides of book covers made of paper to render them stiffer and more durable and a method for attachment of the laminated book covers when hot glue is used in the book binding process. Hot glue used in book binding will not bond with the plastic laminate. Bonding of the book laminated covers can be achieved by bonding a paper strip to the spine area of the laminated covers. The hot glue will then bond to the paper strip in the book binding process.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of Endeavor

The invention relates to using lamination on both sides of soft book covers to improve the durability of the book covers and a method of facilitating the of said book covers when hot glue is used in the process of book binding.

2. Description of Information

Soft book covers now in use are made of heavy and expensive paper which may be plastic coated. These book covers are easily dog-eared, bent or torn in use. Lamination on both sides of has not been used because most book binders use hot glue in the book binding process and the hot glue used will not bond with the lamination of the covers. This invention eliminates these problems.

### BRIEF SUMMARY OF THE INVENTION

This relates to lamination of both sides of soft book covers to make them more durable and a means of facilitating the attachment of said covers when hot glue is used in the process of book binding. The hot glue used in book binding will not bond to the laminate. The advantages of my invention is to make a durable and inexpensive book cover that will be appropriate when hot glue is used in book binding.

### BRIEF DESCRIPTION OF THE SEVERAL VIEWS OF THE DRAWING

FIG. 1 is a plan view of showing details of the embodiment of the laminated book covers and the location of the attachment of the same.

FIG. 2 is a elevation view showing the embodiment of the laminated book covers and means of facilitating the attachment of the same.

### DETAILED DESCRIPTION OF THE INVENTION

The use of soft book covers that are plastic laminated on both sides is discouraged by book binders because most book binders use hot glue in the binding process which will not bond to plastic laminate. Therefore most soft book covers are made of heavy and expensive paper in an effort to try to achieve a durable cover. This invention is a method of facilitating the use of soft book covers that are plastic laminated on both sides to provide a more durable and low cost soft book cover when hot glue is used in the process of book binding. My invention facilitates the use of laminated book covers when hot glue is used that will not bond with the laminated book covers.

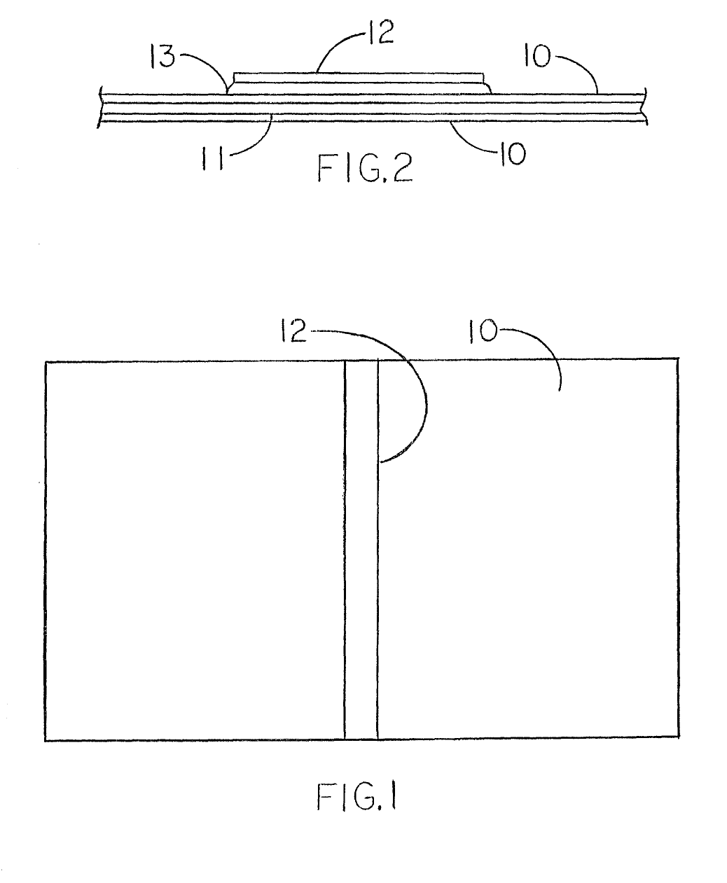

Referring to FIGS. 1 and 2 the embodiment of the invention is shown in which the book cover 11 is shown as covered on both sides with laminate 10. A strip of paper 12 the width and length of the spine of the book is bonded at the spine area of the inside of the book cover with an adhesive 13 as shown in FIG. 2 that will bond to the laminate 10 and the paper strip 12. The hot glue will bond with the paper strip 12 in the attachment of the book cover during the process of the book binding.

What I claim as my invention is:

1. A soft book cover and the attachment of same which comprises:
(a) a book cover;
(b) a lamination of the book cover; and
(c) a means of attachment of the book cover.

2. A soft book cover as recited in claim 1, which further comprises:
(a) a book cover made of paper as thin as 20 pound;
(b) that is laminated on both sides with 3 to 5 mil thick plastic laminate; and
(c) has a means of attachment of the laminated cover to the spine area of the book.

3. A soft book cover as recited in claim 2, wherein the two sided plastic lamination of the said cover makes the cover stiffer, more resistant to scratches, curling or bending, and is more resistant to water damage than coated and uncoated paper book covers while remaining comparable in cost.

4. A soft book cover as recited in claim 2 wherein the method of attachment of said cover is facilitated by bonding a strip of paper the width and length of the spine of the book at the spine area of the inside of the cover with adhesive that will bond with the plastic laminate of the cover.

5. The soft book cover as recited in claim 2 in which the assembled book cover is bonded to the body of the book with the hot glue used in the book binding process which will bond to the paper strip recited in claim 4.
